(19) United States
(12) Patent Application Publication
(10) Pub. No.: US 2010/0287999 A1
(43) Pub. Date: Nov. 18, 2010

(54) Locking Structure for Helmets

(76) Inventor: Chin-Sung Huang, Puxin Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/465,753

(22) Filed: May 14, 2009

(51) Int. Cl. E05B 69/00

(52) U.S. Cl. 70/59

(57) ABSTRACT

A locking structure for helmets comprises a body including an arcuate groove disposed on a bottom surface thereof, an arcuate engaging member fixed on a motorcycle, the body further including a receiving hole formed on one side thereof for receiving a lock core, one distal end of the lock core being locked to a fixing member, wherein the fixing member includes a foot extending from one side thereof and a slot to receive a resilient element, the body further includes a coupling projection and an inserting bore which are pivotally connected with a U-shaped hook member by using a shaft, the groove of the body includes an elastic piece positioned therein to correspond to the inserting bore.

### BACKGROUND OF THE INVENTION

1. Field of the Invention

The present invention relates to a locking structure for helmets that can be fixed on a motorcycle easily to prevent from being stolen.

2. Description of the Prior Art

Helmets are used to protect user's head as riding motorcycle, however the helmets are too large that has to be stored in a receiving chamber under a seat of the motorcycle. If there are two helmets, the other helmet can not be stored in the receiving chamber because the receiving chamber can only receive one helmet. Therefore, the other helmet has to be hanged on the motorcycle, easily to be stolen.

The present invention has arisen to mitigate and/or obviate the afore-described disadvantages.

### SUMMARY OF THE INVENTION

The primary object of the present invention is to provide a locking structure for helmets that can be locked and unlocked easily.

Further object of the present invention is to provide a locking structure for helmets that is simplified and produced easily.

Another object of the present invention is to provide a locking structure for helmets that can be fixed to a suitable position on a motorcycle as desired.

A locking structure for helmets in accordance with a preferred embodiment of the present invention comprises:

a body including an arcuate groove disposed on a bottom surface thereof and two opposite locking tabs mounted on two lower side surfaces of a lower end thereof respectively, an arcuate engaging member including two locking openings fixed on two sides thereof individually, the engaging member being fixed on a post of a rearview mirror, a rear handle or related parts of a motorcycle by using at least one first fastening element, the body also including a receiving hole formed on one side thereof for receiving a lock core, one distal end of the lock core being locked to a fixing member by means of a second fastening element and a washer, the fixing member including a recess to receive the lock core and including a foot extending from one side thereof, the foot including an inclined plane arranged on one side thereof, and the fixing member further including a slot to receive a resilient element, the body further including a coupling projection and an inserting bore which are pivotally connected with a U-shaped hook member by using a shaft, the hook member including a connecting portion disposed on one end thereof and an insertion portion mounted on another end thereof, the insertion portion including a notch and a circular pushing head, the groove of the body including an elastic piece positioned therein in a riveting manner to correspond to the inserting bore.

### BRIEF DESCRIPTION OF THE DRAWINGS

FIG. 1 is a perspective view showing the exploded components of a locking structure for helmets according to a preferred of the present invention;

FIG. 2 is a perspective view showing the assembly of the locking structure for helmets according to the preferred embodiment of the present invention;

FIG. 3 is a cross section view showing the assembly of the locking structure for helmets according to the preferred embodiment of the present invention;

FIG. 4 is another cross section view showing the assembly of the locking structure for helmets according to the preferred embodiment of the present invention;

FIG. 5 is a cross sectional view showing the operation of locking the locking structure for helmets according to the preferred embodiment of the present invention;

FIG. 6 is a cross sectional view showing the operation of locking the locking structure for helmets according to the preferred embodiment of the present invention;

FIG. 7 is a cross sectional view showing the operation of unlocking the locking structure for helmets according to the preferred embodiment of the present invention;

FIG. 8 is another cross sectional view showing the operation of unlocking the locking structure for helmets according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

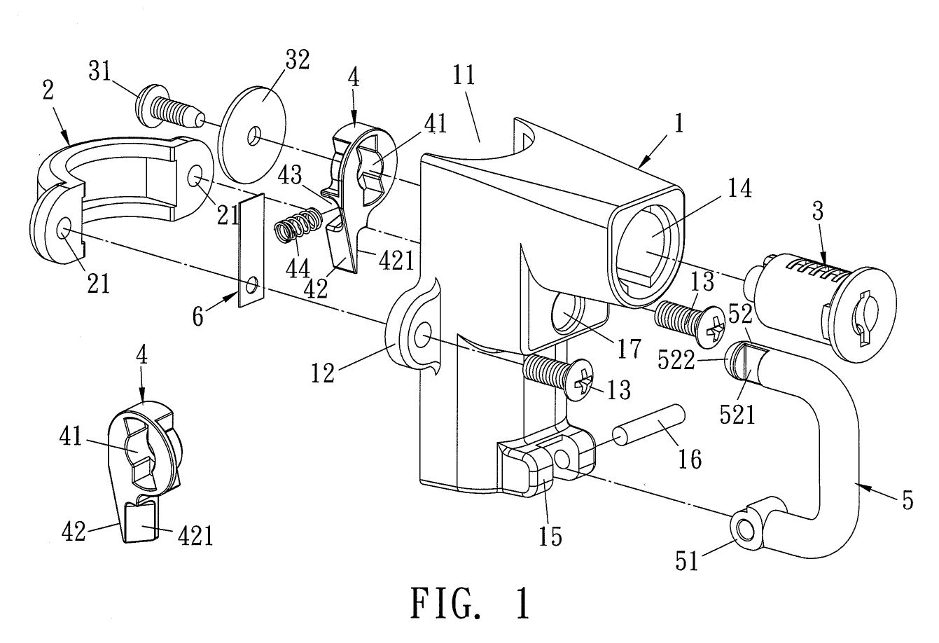

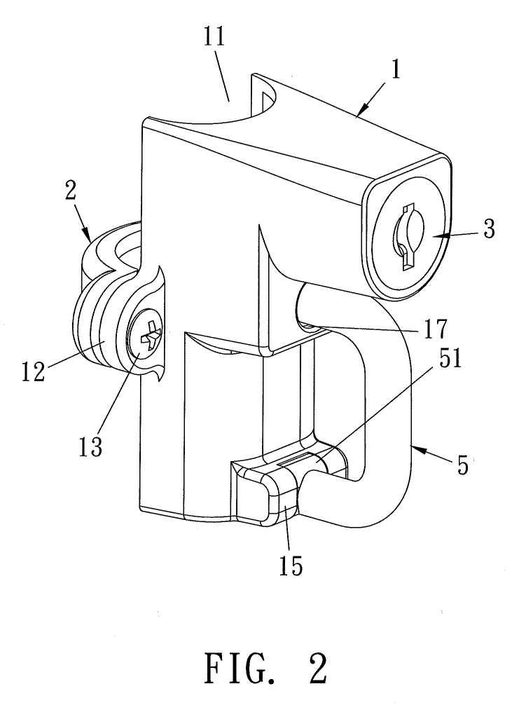

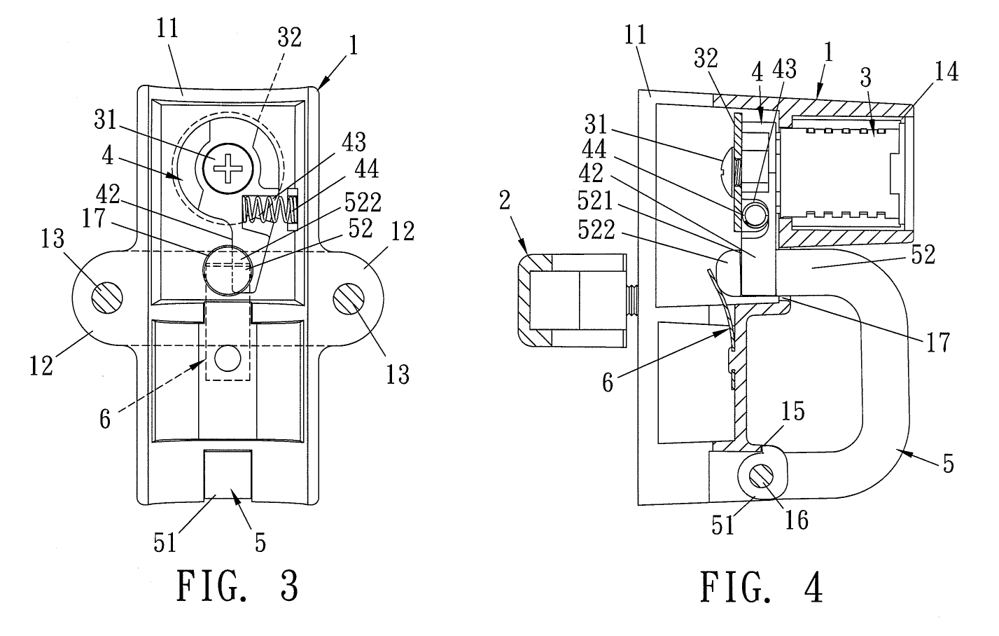

Referring to FIGS. 1-4, a locking structure for helmets in accordance with a preferred embodiment of the present invention comprises: a body 1 including an arcuate groove 11 disposed on a bottom surface thereof and two opposite locking tabs 12 mounted on two lower side surfaces of a lower end thereof respectively, an arcuate engaging member 2 including two locking openings 21 fixed on two sides thereof individually, the engaging member 2 being fixed on a post of a rearview mirror, a rear handle or related parts of a motorcycle by using at least one first fastening element 13, the body 1 also including a receiving hole 14 formed on one side thereof for receiving a lock core 3, one distal end of the lock core 3 being locked to a fixing member 4 by means of a second fastening element 31 and a washer 32, the fixing member 4 including a recess 41 to receive the lock core 3 and including a foot 42 extending from one side thereof, the foot 42 including an inclined plane 421 arranged on one side thereof, and the fixing member 4 further including a slot 43 to receive a resilient element 44, the body 1 further including a coupling projection 15 and an inserting bore 17 which are pivotally connected with a U-shaped hook member 5 by using a shaft 16, the hook member 5 including a connecting portion 51 disposed on one end thereof and an insertion portion 52 mounted on another end thereof, the insertion portion 52 including a notch 521 and a circular pushing head 522, the groove 11 of the body 1 including an elastic piece 6 positioned therein in a riveting manner to correspond to the inserting bore 17.

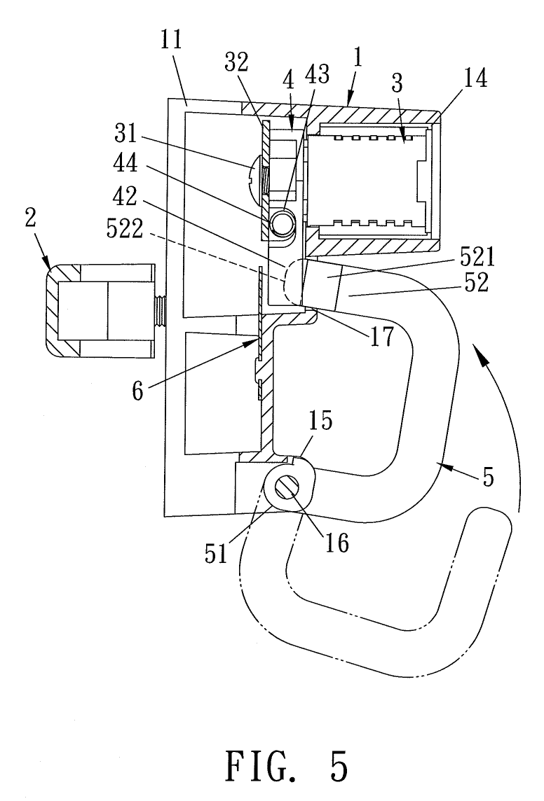

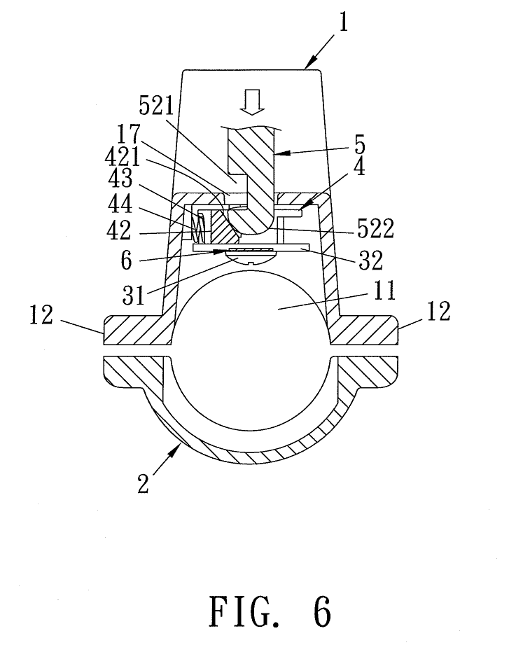

While desiring to locking the helmet as illustrated in FIGS. 5 and 6, the helmet is hooked on the hook member 5, and the insertion portion 52 of the hook member 5 is rotatably inserted into the inserting bore 17 of the body 1, such that the pushing head 522 of the insertion portion 52 pushes against the inclined plane 421 of the foot 42 of the fixing member 4 so that the fixing member 4 rotatably presses the resilient element 44. As the insertion portion 52 of the hook member 5 is inserted and positioned, the elastic piece 6 is deformable because of being pushed by the hook member 5, and the fixing member 4 is biased against by the resilient element 44 to rotate in an opposite direction so that the foot 42 locks in the notch 521 of the insertion portion 52 of the hook member 5, thereby locking the helmet.

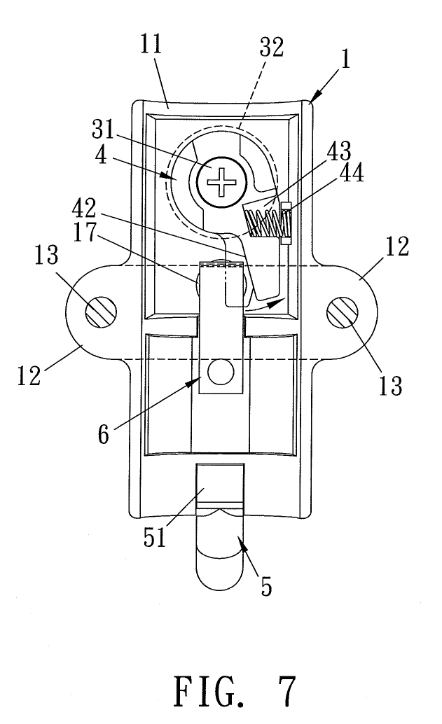

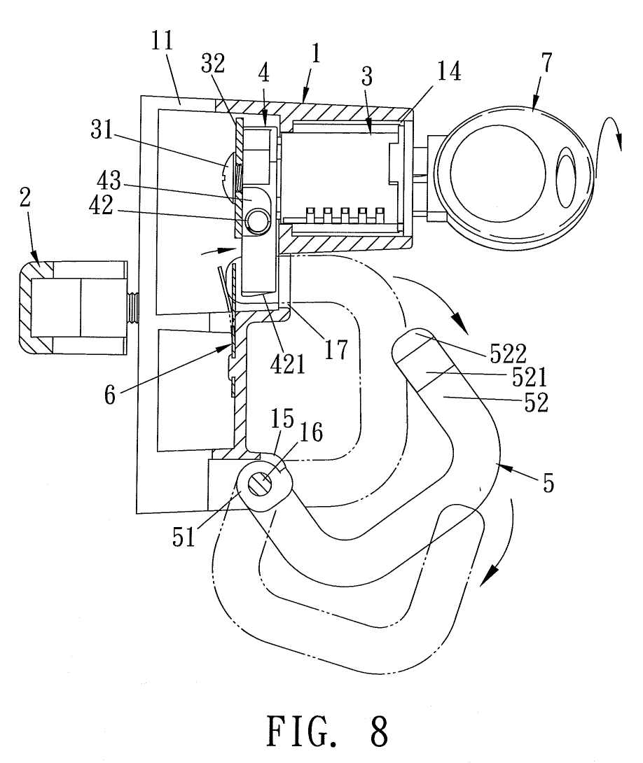

While unlocking the helmet as shown in FIGS. 7 and 8, a key 7 is inserted to an aperture of the lock core 3 to be rotated so as to actuate the fixing member 4 to rotate, such that the foot 42 of the fixing member 4 disengages from the notch 521 of the insertion portion 52 of the hook member 5, and then the hook member 5 bounces automatically by using the resilience of the elastic piece 6, thus unlocking the helmet.

It is apparent form the above description that the present invention has the following advantages:

1. The locking structure of the helmets can be locked directly without using the key 7, and as unlocking the locking structure, the hook member 5 bounces automatically by using the resilience of the elastic piece 6, thus locking and unlocking the locking structure easily.

2. The locking structure is simplified and produced easily.

3. The locking structure can be fixed to a suitable position on the motorcycle as desired.

While we have shown and described various embodiments in accordance with the present invention, it is clear to those skilled in the art that further embodiments may be made without departing from the scope of the present invention.

What is claimed is:

1. A locking structure for helmets comprising:
a body including an arcuate groove disposed on a bottom surface thereof, an arcuate engaging member fixed on a motorcycle, the body further including a receiving hole formed on one side thereof for receiving a lock core, one distal end of the lock core being locked to a fixing member, wherein
the fixing member including a foot extending from one side thereof and a slot to receive a resilient element, the body further including a coupling projection and an inserting bore which are pivotally connected with a hook member by using a shaft, the groove of the body including an elastic piece positioned therein to correspond to the inserting bore.

2. The locking structure for helmets as claimed in claim 1, wherein one distal end of the lock core is locked to the fixing member by means of a second fastening element and a washer.

3. The locking structure for helmets as claimed in claim 1, wherein the fixing member includes a recess to receive the distal end of the lock core.

4. The locking structure for helmets as claimed in claim 1, wherein the foot includes an inclined plane arranged on one side thereof.

5. The locking structure for helmets as claimed in claim 1, wherein the hook member is formed in a U shape.

6. The locking structure for helmets as claimed in claim 1, wherein the hook member includes a connecting portion disposed on one end thereof and an insertion portion mounted on another end thereof, the insertion portion includes a notch and a circular pushing head.

7. The locking structure for helmets as claimed in claim 1, wherein the elastic piece is positioned in the groove of the body in a riveting manner.
